(19) United States
(12) Patent Application Publication
(10) Pub. No.: US 2006/0047820 A1
(43) Pub. Date: Mar. 2, 2006

(54) System and method for monitoring simultaneous PoC sessions

(75) Inventors: Sang-Kyung Sung, Suwon-si (KR); Joon-Goo Park, Yongin-si (KR); Sung-Jin Park, Suwon-si (KR); Jea-Hun Han, Suwon-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/103,790

(22) Filed: Apr. 12, 2005

(30) Foreign Application Priority Data
Apr. 19, 2004 (KR) 26882/2004

(51) Int. Cl. G06F 15/16

(52) U.S. Cl. 709/227

(57) ABSTRACT

The system includes a push to talk over cellular (PoC) client for requesting storage of media data of a sub-participation session among the simultaneous sessions, a storage part for storing the media data of the sub-participation session, and a push to talk over cellular (PoC) server for transmitting the media data of the sub-participation session stored in the storage part to the push to talk over cellular client according to a read out request of the push to talk over cellular client.

### PRIORITY

This application claims priority to an application entitled “System and Method for Monitoring Simultaneous PoC Sessions” filed in the Korean Intellectual Property Office on Apr. 19, 2004 and assigned Serial No. 2004-26882, the contents of which are incorporated herein by reference.

### BACKGROUND OF THE INVENTION

1. Field of the Invention

The present invention relates to a system and method for mobile communication, and more particularly, to a system and method for a ‘push to talk over cellular (PoC)’ service, which can achieve fast communication for both business users and personal users.

2. Description of the Related Art

Cellular phones provide more and more varied services and applications as a result of telecommunication network expansion and the development of a world-wide mobile communication standard. Users have come to expect greater improvements in quality in addition to subdivided services including location-based service, multimedia service, and a push to talk service (PTT), which provides a connection between different types of networks like a broadcasting network and the Internet with simple communication services.

In particular, ‘push to talk over cellular’ (PoC) service refers to a service with speedy call set-up and an ad hoc network with the establishment of a group session between predetermined users by using an SIP protocol and an SIP/IP(Session Initiation Protocol/Internet Protocol) core network.

Hereinafter, a typical structure of a ‘push to talk over cellular’ (PoC) system will be described with reference to FIG. 1. The PoC system uses an SIP/IP core network as an infrastructure and functions of multimedia service systems based on an IP protocol employed in the 3GPP (3rd Generation Partnership Project) or the 3GPP2.

Referring to FIG. 1, a PoC client 10 denotes a service requestor embedded in a mobile terminal or constructed as a separated device and is connected to an SIP/IP core network 30 (a core network supporting an SIP and IP multimedia) through a wireless access network 20. The SIP/IP core network 30 is connected to a PoC server 60, a group list and management system (GLMS) 50, and a presence server 70.

The PoC server 60 performs a control function of maintaining and managing PoC sessions and a participation function of managing client participation in the PoC sessions established for one-to-one communication or many-to-many communication. In the PoC service system structure, it is necessary to manage lists and PoC participation groups intending to participate in many-to-many sessions to establish the many-to-many sessions. Accordingly, the group list and management system 50 provides the groups and the lists, and a group management/administration part 40 manages the groups and the lists.

The presence server 70 provides and manages information about whether or not individuals or groups intending to provide PoC services exist. Meanwhile, a remote PoC network 80 represents an SIP/IP core network and a PoC server for connection with another user for communication.

FIG. 2 is a flowchart showing a procedure of establishing plural PoC sessions in the PoC service system described above and shows a PoC client B 140 as a predetermined PoC client connected to a predetermined Participating PoC server B 120 managing client participation and establishing a PoC session with a predetermined session group.

The PoC client B 140, requiring simultaneous sessions, participates in plural PoC sessions by using a Participating PoC function unit of a network Participating PoC server B 120 covering the PoC client 140. A talk burst control message for the sessions includes information regarding an idle state or an acquisition state of a floor in each session. Herein, PoC servers (Controlling PoC server X1 100, Controlling PoC server X2 110, and Controlling PoC server X3 130) connected to the Participating PoC server B 120 control each established group PoC session or each established individual PoC session and establish sessions with other users through the Participating PoC function unit in each session.

Referring to FIG. 2, the PoC client B 140 simultaneously receives media data such as voice streams from sessions established with the Controlling PoC servers 100, 110, and 130 through the SIP/IP core network in steps 150, 152, and 154. The Participating PoC server B 120 selectively transmits media data incoming through simultaneous sessions to the PoC client 140 by filtering the media data in step 156. Herein, through the filtering of the Participating PoC server B 120 which manages the PoC client B 140, an actively participating PoC session and a non-actively participating PoC session are distinguished according to the requirement of the PoC client B 140, and media packets such as voice streams in the actively participating PoC session are delivered to the PoC client B. To this end, according to convention, when simultaneous PoC sessions are realized, a sub-participation session is selected and media data are preoccupied by transmitting session priority and a locking signal for a selected session to a Participating PoC function unit according to the requirement of a PoC user.

However, in the conventional technique of handling simultaneous PoC sessions, a management function for a main participation session and a sub-participation session in simultaneous sessions, a session change function, and a session monitoring function, may be given according to PoC user requirements when media signals are simultaneously received from a number of sessions. When this occurs, a PoC client cuts off packet streams of undesired sessions by filtering a Participating PoC server covering the PoC client, and receives only one call by means of media allocated between the PoC client and the Participating PoC server.

For example, when packets are received from a session relating to the Controlling PoC server X1 100 only from among three sessions established with the PoC client B 140 as shown in FIG. 2, communication data through another session filtered by the Participating PoC server cannot be received by the user. In the conventional technique, if the user is activated in the sub-participation session and if talk burst starts through a media channel of the main participation session, talk burst receiving channel is immediately changed into the talk burst receiving channel of the main participation session. With this method, information of a participating sub-channel may be lost.

To overcome such a disadvantage, the conventional technique has a method of delivering data of the sub-participation session to a client by selectively converting the data into storable text, storable character signals in addition to storable voice signals, etc. according to the request of the PoC client. However, when the data of the sub-participation session is converted into a text message in real time, errors are likely to occur as well as time delays from executing the text-to-speech (TTS) algorithm. In addition, when instant character streams are missed during conversion of visible/audible information, it is difficult to confirm the missed character streams, and therefore, difficult to recover them.

### SUMMARY OF THE INVENTION

Accordingly, the present invention has been made to solve the above-mentioned problems occurring in the prior art, and an object of the present invention is to provide a system and a method which allow a PoC client in simultaneous PoC sessions to monitor other sub-participation sessions than a main participation session in which the PoC client participates.

Another object of the present invention is to provide a system and a method which allow a PoC client in simultaneous PoC sessions to reuse communication data of other sub-participation sessions than a main participation session in which the PoC client mainly participates, thereby allowing the PoC client to receive a variety of services.

To accomplish the above objects, there is provided a system for monitoring simultaneous sessions for a push to talk over cellular (PoC) service, the system including: a push to talk over cellular (PoC) client for requesting storage of media data of a sub-participation session among the simultaneous sessions; a storage part for storing the media data of the sub-participation session; and a push to talk over cellular (PoC) server for transmitting the media data of the sub-participation session stored in the storage part to the push to talk over cellular client according to a read out request of the push to talk over cellular client.

According to another aspect of the present invention, there is provided a method for monitoring simultaneous sessions in a push to talk over cellular (PoC) system, the method including the steps of: requesting a main participation session to a push to talk over cellular server by a push to talk over cellular client; storing data of a sub-participation session by the push to talk over cellular server; requesting a read-out operation for the stored data by the push to talk over cellular client; and reading out the stored data of the sub-participation session so as to transmit read-out data to the push to talk over cellular client by the push to talk over cellular server.

According to still another aspect of the present invention, there is provided a push to talk over cellular client for monitoring simultaneous sessions, the push to talk over cellular client requesting a push to talk over cellular server to store data of a sub-participation session, requesting the push to talk over cellular server to transmit the data of the sub-participation session, and receiving the data.

According to still another aspect of the present invention, there is provided a method for monitoring simultaneous sessions based on a push to talk over cellular client in a push to talk over system, the method including the steps of: requesting by the push to talk over cellular client a push to talk over cellular server to store data of a sub-participation session; requesting the push to talk over cellular server to transmit the data of the sub-participation session; and activating and transmitting the stored data of the sub-participation session.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram showing a structure of a conventional PoC system;

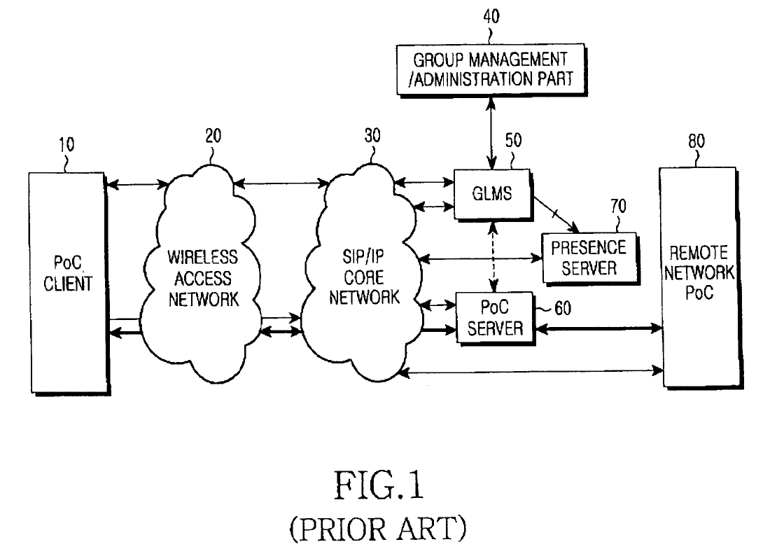

FIG 2 is a flowchart showing an operation of the conventional PoC system of FIG. 1;

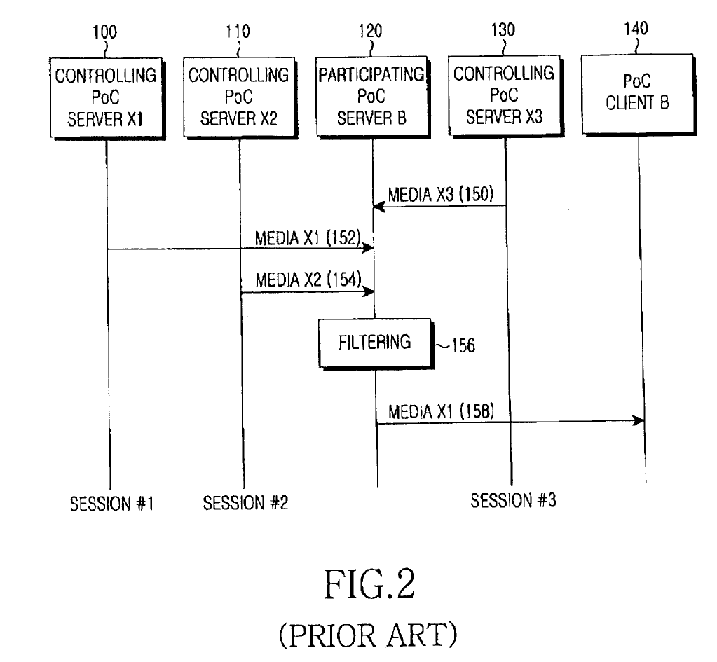

FIG. 3 is a block diagram showing a structure of a system for monitoring simultaneous sessions according to a preferred embodiment of the present invention; and

FIG. 4 is a flowchart showing a method for monitoring simultaneous sessions according to a preferred embodiment of the present invention.

### DETAILED DESCRIPTION OF THE PREFERRED EMBODIMENT

Hereinafter, preferred embodiments of the present invention will be described in detail with reference to the accompanying drawings. Note that the same or similar components in drawings are designated by the same reference numerals as far as possible although they are shown in different drawings. In the following description of the present invention, a detailed description of known functions and configurations incorporated herein will be omitted when it may make the subject matter of the present invention unclear.

The present invention proposes a technique in which, when a PoC client simultaneously participating in plural sessions receives data of a session selected by the PoC client through a main media channel such as a voice channel, the PoC client monitors data being processed in another session established through an SIP/IP core network and records the data so as to reproduce and confirm data of a sub-participation session, in which the PoC client does not mainly participate, in non-real time according to the requirement of a user.

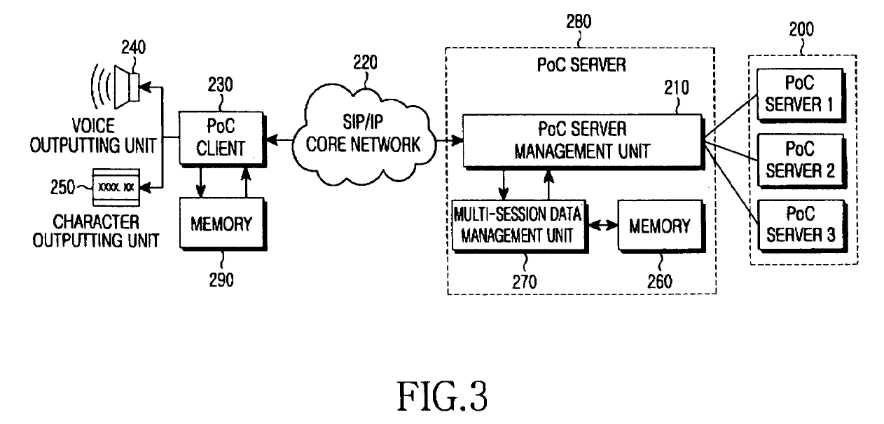

Hereinafter, a structure of a system for monitoring a sub-participation session of simultaneous PoC sessions according to the present invention will be described with reference to FIG. 3.

Simultaneous PoC sessions controlled by a PoC server 1, a PoC server 2, and a PoC server 3 form a PoC session group 200 connected to a user and a PoC server management unit (Participating PoC function) 210, which manages a session connected PoC client 230, in a PoC server 280. Herein, a server administering sessions of the user is called a “Home PoC server”. The PoC server 280 participates in a group session through a Controlling PoC function and a Participating PoC function (which are its own functions) to control the session. As described above, elements for simultaneous session filtering and monitoring are connected to the PoC session group (Controlling PoC function) 200 for controlling participation sessions through the PoC server management unit 210 of the home PoC server of the user.

The PoC server management unit 210 of the PoC server 280 filters transmitted packets according to user requirement information to transmit only selected packet streams to the PoC client 230 through an SIP/IP core network 220, such as an IMS core network of the 3GPP.

The PoC server 280 includes multi-session data management unit 270 and a memory 260 for storing talk burst data in order to maintain and manage plural talk burst sessions and the talk burst data when the talk burst exists in some simultaneous sessions.

The multi-session data management unit 270 distinguishes media data of a sub-participation session filtered in the PoC server management unit 210 and delivers the media data to the memory 260. In addition, when the PoC server management unit 210 makes a call according to the requirement of the PoC client, the multi-session data management unit 270 detects stored talk burst data of a specific session in the memory to deliver the detected talk burst data to the PoC server management unit 210. The multi-session data management unit 270 can compress media streams and transmit the, to the memory 260.

The memory 260 stores talk burst data of a sub-participation session while matching the talk burst data with PoC session identifiers or floor holder identifiers according to the control of the multi-session data management unit 270. The memory 260 selectively stores sub-participation session group burst data excluding those of a main participation session group according to the requirement of the PoC client. Herein, the sub-participation session group burst data stored in memory are transmitted to a user after transmission of of the main participation session talk burst. Otherwise, the user may receive the stored talk burst data after termination of the main participation session. Alternatively, the user may receive the stored burst data after termination of all simultaneous sessions.

The multi-session data management unit 270 and the memory 260 may be constructed as forms embedded in the PoC server 280. Alternatively, the multi-session data management unit 270 and the memory 260 may be separate, external devices connected to the PoC server management unit 210.

The PoC client 230 outputs media data transmitted from the PoC server 280 to a voice outputting unit 240 or a character outputting unit 250 that converts the media data into voice or characters. In addition, sub-participation session group burst data, excluding the main participation session group burst data, are selectively transmitted to the PoC client and can be stored in a memory 290 of the PoC client according to the requirement of the PoC client. Herein, the PoC client may reproduce talk burst data stored in the memory 290 after the main participation session talk burst is terminated. Occasionally, a user may reproduce the contents of the talk burst after the PoC client terminates the main participation session. Alternatively, the user may reproduce the contents of the talk burst after all simultaneous sessions are terminated.

The PoC client 230 can request the storage of talk burst data of at least one sub-participation session, and the PoC server 280 can store plural filtered media data, session identifiers, and floor holder identifiers corresponding to the media data in the memory 260 according to the request. In addition, the PoC client 230 can reproduce the media data using the identifiers when needed.

The voice outputting unit 240, the character outputting unit 250, and the memory 290 may be embedded in a mobile terminal having the PoC client such as a PoC phone, or may be constructed as devices separate from the mobile terminal and connected to the mobile terminal through connection units.

The concept of storing media data of a sub-participation session is employed similarly for two forms constructed as described above. However, when the PoC client and the memory are embedded in one terminal, since the PoC client may simultaneously receive media data of other sessions in addition to the main participation session from the PoC server, the load of the mobile communication access network is reduced.

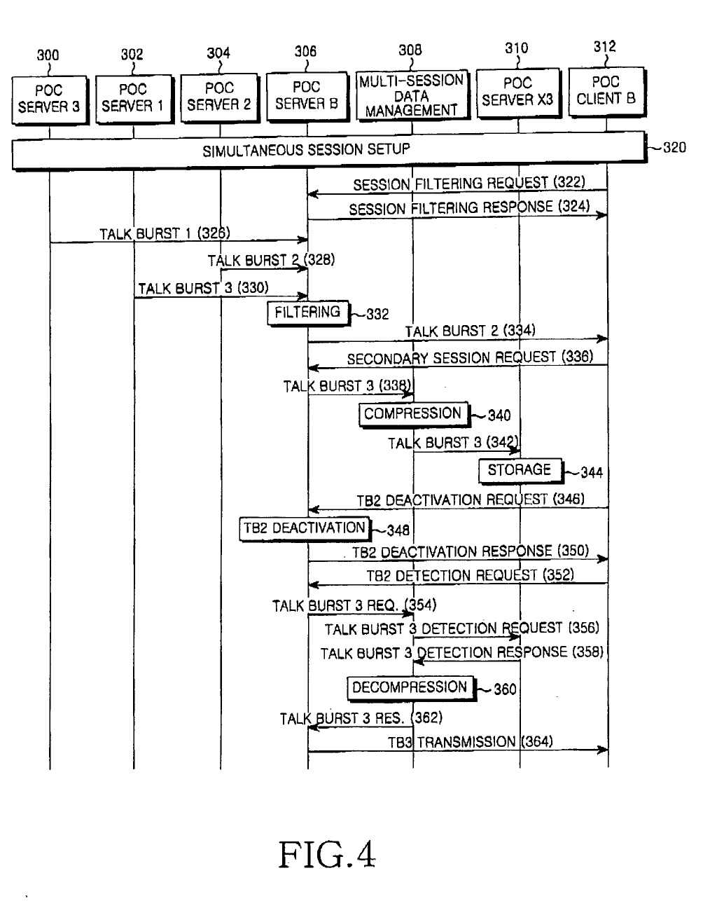

Hereinafter, a method for monitoring simultaneous PoC sessions according to a preferred embodiment of the present invention will be described with reference to FIG. 4.

FIG. 4 is a flowchart showing a method in which, when a memory is linked with a PoC server and, when a main participation session from among the simultaneous sessions is not terminated, media data of the main participation session is held temporarily, and packets received from one sub-participation session are stored and then reproduced according to the PoC client rquirements.

In FIG. 4, a PoC client B 312, intending to participate in simultaneous sessions, initializes SIP/IP based communication with PoC servers 300, 302, and 304 in plural PoC group sessions through simultaneous session set up in step 320. The PoC client B 312 transmits a session filtering request message to the PoC server B 306 in order to request a session for participation in step 322. Then, the PoC server B 306 transmits main participation session selection information to the PoC client B 312 in response to step 322 in step 324. Herein, if the PoC servers 300, 302, and 304 send talk burst in steps 326, 328, and 330 through the sessions set up in step 320, the PoC server B 306 may filter transmission packets excluding those of the group session requested by the PoC client through a Participating PoC function unit in step 332. After that, the PoC server B 306 sends transmission packets of only one session requested by the PoC client to the PoC client B 312 in step 334.

When the PoC client B 312 intends to detect data of sub-participation sessions excluding data of the main participation session, the PoC client B 312 transmits a secondary session request message including a session identifier for participation to the PoC server B 306 in step 336. Herein, the PoC server B 306 delivers talk burst data of a PoC session selected by the PoC client B 312 to a multi-session data management unit 308 in the PoC server in step 338. Then, the multi-session data management unit 308 compresses the received talk burst data of the PoC session into media data in efficiently store the talk burst data in step 340. After that, the multi-session data management unit 308 sends the compressed talk burst data of the PoC session to a storage part 310 connected to the PoC server in step 342. The storage part 310 stores the compressed talk burst data of the PoC session with the session identifier and each session floor holder identifier in step 344.

When the main participation session and sub-participation session usage changes according to user requirements, the PoC client B 312 requests the PoC server B 306 to deactivate talk burst of the current main participation session in step 346. Thereafter, the PoC server B 306 deactivates media of the main participation session in step 348, and then, responds to the PoC client with the deactivation result in step 350.

If deactivation of the main participation session is confirmed, the PoC client B 312 requests the reproduction for talk burst data of sessions stored in the PoC server B 306 in step 352. Then, the PoC server B 306 sends the talk burst data requested by the client to the multi-session data management unit 308 in step 354. After that, the multi-session data management unit 308 detects stored media data based on the session identifier and each session floor holder identifier in step 356 and step 358. The multi-session data management unit 308 decompresses the detected media data in step 360, and then, transmits the decompressed media data to the PoC server B in step 362. Then, the PoC server B 306 transmits the data to the PoC client B 312 in step 364.

According to an alternative embodiment, when session filtering is requested in step 322, the PoC client B 312 may request both data of the main participation session and data of the sub-participation session to be stored. At this time, the PoC server B may transmit the data of one main participation session to the PoC client B 312 through media. In addition, the PoC server B may transmit transmission data of the sub-participation session to the multi-session data management unit 308 therein and store the transmission data of the sub-participation session.

According to a further alternative embodiment, differently from FIG. 4, the time at which stored media data of another session is transmitted may be limited to the time at which the main participation session is terminated.

According to yet another embodiment, the time at which stored media data of another session is transmitted may be limited to a time at which all simultaneous sessions are terminated.

As described above the present invention has the following effects:

First, when other sessions in addition to a main participation session are monitored, it is possible to detect detailed data of a PoC call as well as floor states of other PoC group sessions.

Second, a PoC client in simultaneous sessions can detect data of a PoC session regardless of environment by storing talk burst data transmitted from an important sub-participation session or an interesting sub-participation session.

Third, when a main participation session and a sub-participation session are changed into each other depending on a floor idle state and priority determined by a user, it is possible to efficiently manage media in a PoC channel by using the above technique.

Fourth, when media data are converted into a data type of another medium including a character in order to monitor data of a sub-participation session, it is possible to remove any errors that may occur.

While the invention has been shown and described with reference to certain preferred embodiments thereof, it will be understood by those skilled in the art that various changes in form and details may be made therein without departing from the spirit and scope of the invention. Consequently, the scope of the invention should not be limited to the embodiments, but should be defined by the appended claims and equivalents thereof.

What is claimed is:

1. A system for monitoring simultaneous sessions for a push to talk over cellular (PoC) service, the system comprising:
a push to talk over cellular (PoC) client for requesting storage of media data of a sub-participation session among the simultaneous sessions;
a storage part for storing the media data of the sub-participation session; and
a push to talk over cellular (PoC) server for transmitting the media data of the sub-participation session stored in the storage part to the PoC client according to a read out request of the push to talk over cellular client.

2. The system as claimed in claim 1, wherein the PoC server includes:
a management unit for filtering data of the sub-participation session; and
a memory unit for storing the data.

3. The system as claimed in claim 2, wherein the POC server further includes a session data management unit for compressing the data stored in the memory unit or for decompressing compressed data stored therein.

4. The system as claimed in claim 2, wherein the memory unit stores the data of the sub-participation session by matching the data with a session identifier.

5. The system as claimed in claim 1, wherein data of the sub-participation session are talk burst data.

6. The system as claimed in claim 1, wherein the memory unit is not embedded in the POC server, but is constructed as a device separated from and linked with the PoC server.

7. The system as claimed in claim 1, wherein, when the stored data of the sub-participation session are transmitted, a main participation session is in one of a deactivation state and a termination state.

8. A method for monitoring simultaneous sessions in a push to talk over cellular (PoC) system, the method comprising:
requesting a main participation session to a PoC server by a PoC client;
storing data of a sub-participation session by the PoC server;
requesting a read-out operation for the stored data by the PoC client; and
reading out the stored data of the sub-participation session so as to transmit read-out data to the PoC client by the PoC server.

9. The method as claimed in claim 8, further comprising requesting the PoC server to store the data of the sub-participation session by PoC client.

10. The method as claimed in claim 8, further comprising filtering the data of the sub-participation session by the PoC server.

11. The method as claimed in claim 8, further comprising compressing the stored data and decompressing compressed data by the PoC server.

12. The method as claimed in claim 8, wherein the memory unit stores the data of the sub-participation session by matching the data with a session identifier.

13. The method as claimed in claim 8, wherein data of the main participation session and the sub-participation session are talk burst data.

14. The method as claimed in claim 8, wherein the memory unit is not embedded in the POC server, but is constructed as a device separated from and linked with the PoC server.

15. The method as claimed in claim 8, wherein, when the stored data of the sub-participation session are transmitted, a main participation session is in one of both a deactivation state and a termination state.

16. A push to talk over cellular (PoC) client for monitoring simultaneous sessions, the PoC client requesting a PoC server to store data of a sub-participation session, requesting the PoC server to transmit the data of the sub-participation session, and receiving the data.

17. The push to talk over cellular client as claimed in claim 16, wherein, when the stored data of the sub-participation session are transmitted, a main participation session is in one of both a deactivation state and a termination state.

18. The push to talk over cellular client as claimed in claim 16, wherein the received data are output as one of audible data and visible data.

19. A method for monitoring simultaneous sessions based on a push to talk over cellular (PoC) client in a push to talk over system, the method comprising the steps of:
requesting a PoC server to store data of a sub-participation session by the PoC client;
requesting the PoC server to transmit the data of the sub-participation session; and
activating and transmitting the stored data of the sub-participation session to the PoC client by the PoC server.

20. The method as claimed in claim 19, wherein, when the stored data of the sub-participation session are transmitted, a main participation session is in one of a deactivation state and a termination state.

21. The method as claimed in claim 19, wherein received data are output as one of audible data and visible data.
